(19) United States
(12) Patent Application Publication
(10) Pub. No.: US 2024/0410146 A1
(43) Pub. Date: Dec. 12, 2024

(54) Sanitary Fitting and Sanitary Fitting System

(71) Applicant: Viega Technology GmbH & Co. KG, Attendorn (DE)

(72) Inventors: Daniel Görke, Lennestadt (DE); Thomas Knupfer, Scharans (CH); Daniel Knupfer, Zizers (CH); Eric Robinson, Trin-Mulin (CH)

(21) Appl. No.: 18/739,787

(22) Filed: Jun. 11, 2024

(30) Foreign Application Priority Data
Jun. 12, 2023 (DE) 10 2023 115 254.8

(51) Int. Cl. E03C 1/04; F16K 31/60

(52) U.S. Cl. CPC E03C 1/0412; F16K 31/605

(57) ABSTRACT

A sanitary fitting including a fitting body, a water connection, a water outlet or water exit and a movable operating element having a lever, wherein the lever is rotatable about a first axis of rotation to control a water temperature and is tiltable about a second axis of rotation to control a water flow. According to the invention, a sensor device for detecting various positions of the lever of the movable operating element relative to a fixed position of the fitting body is arranged in the fitting body. The sanitary fitting can advantageously be combined with a mixing unit which can be electronically controlled by means of the operating element, the mixing unit having a connection for cold water, a connection for hot water, a connection for a mixed water line connectable to the sanitary fitting, at least two independently controllable valves for setting the temperature and volume flow of the mixed water to be dispensed via the connection for the mixed water line and drives controlling the valves. The sanitary fitting according to the invention offers intuitive manual operation for setting the water temperature and flow rate and enables improved hygienic flushing.

### CROSS-REFERENCE TO RELATED APPLICATION

This application claims priority to German Patent Application No. 10 2023 115 254.8 filed Jun. 12, 2023, the disclosure of which is hereby incorporated by reference in its entirety.

### BACKGROUND OF THE INVENTION

### Field of the Invention

The invention relates to a sanitary fitting comprising a fitting body, a water connection, a water outlet or water exit and a movable operating element having a lever, wherein the lever is rotatable about a first axis of rotation to control a water temperature and is tiltable about a second axis of rotation to control a water flow.

Furthermore, the invention relates to a sanitary fitting system with a sanitary fitting of the aforementioned type and a mixing unit associated with the sanitary fitting and electronically controllable by means of the operating element, wherein the mixing unit has a connection for cold water, a connection for hot water, a connection for a mixed water line connectable to the sanitary fitting, at least two independently from each other controllable valves for setting the temperature and volume flow of the mixed water to be dispensed via the connection for the mixed water line and drives controlling the valves.

Fittings in plumbing or piping technology are understood to mean, in particular, devices that are used to shut off and control a fluid flow (e.g. water flow). Various types of taps are known, which are used in bathrooms and kitchens in particular.

With the so-called mixing tap—also known as a two-handle tap—the hot water flow and the cold water flow are controlled independently of each other by means of two handles. As the water temperature has to be newly set each time water is tapped, the consumption of unused water is high with such taps.

With single-lever mixers, the water flow and water temperature are controlled by a single lever-shaped handle. As the desired water temperature can be set more quickly with a single-lever mixer than with a mixing tap, the single-lever mixer enables more economical water consumption. Another advantage of a single-lever mixer is that the water temperature and flow rate can be set intuitively by the user with a single hand movement.

However, conventional single-lever mixers cannot be subjected to automatic hygiene flushing, as the valve in them is purely mechanical and the associated lever must be operated manually to open and close the valve.

Automatic hygiene flushing of drinking water installations is a proven measure for maintaining the quality of drinking water. The quality of drinking water changes in drinking water installations, e.g. due to contact with materials, heating and/or downtimes. Longer downtimes of drinking water can lead to the growth of harmful bacteria (legionella). For this reason, regular water exchange based on the intended operation of the relevant drinking water installation by the use of automatic hygiene flushing is increasingly required nowadays.

### Description Of Related Art

A known example is the GRANDIS E kitchen tap marketed by the company Schell. This kitchen tap has a swivel spout and offers two options for activation. It has a single-lever mixer that allows the flow rate and water temperature to be adjusted individually for each use. In addition, this kitchen mixer tap has an infrared sensor for contactless activation by close reflection of infrared light, which controls a solenoid valve in combination with the associated electronics. The solenoid valve is equipped with adjusting screws for setting the mixing ratio of hot and cold water and thus the water temperature, as well as for setting the water volume. In combination with an electronic water management system, the solenoid valve of this kitchen tap enables regular hygiene flushes, also known as stagnation flushes.

However, due to the two triggering options, this known kitchen tap has several water line sections that define a dead space that is difficult to flush, which is disadvantageous in terms of maintaining a high quality of drinking water. The combination of a manually operated single-lever mixer cartridge and an additional solenoid valve that can be triggered contactlessly via an infrared sensor results in additional components and costs.

AT 16 285 U1 discloses a terminal sanitary fitting with a flushing arrangement that is designed to flush stagnant water out of the sanitary fitting or a drinking water installation. The sanitary fitting comprises a fitting body coupled to a line for incoming hot water and a line for incoming cold water, at least two outlets, an actuating device of the type of a single-lever mixer and a first valve coupled to the actuating device, with which the temperature of the mixed water resulting from the mixing ratio of the hot water and cold water is set by swivelling the actuating device when drinking water is withdrawn and the volume flow of the mixed water is set when the actuating device is tilted. The first valve is designed as an assembly from a control valve and a shut-off valve coupled to the control valve via a line for mixed water, wherein the first valve is coupled to a first of the outlets. Furthermore, the sanitary fitting comprises a second valve, which is coupled to the first outlet and is designed to flush the line for incoming cold water, and at least one further valve corresponding to the second or further outlet, which further valve is coupled to the line for mixed water.

The sanitary fitting known from AT 16 285 U1 has several water line sections due to the number of outlets and valves, which represent a dead space that is difficult to flush, so that stagnation and legionella formation can still occur with this known sanitary fitting.

In purely electronic fittings with a solenoid valve and infrared sensor for contactless triggering of the solenoid valve, the hygienic flush can be carried out by means of a corresponding control using an electronic drinking water management system, but the mechanically adjustable mixer shaft or mixer cartridge cannot be used for selective hygienic flushing of cold water or hot water. Depending on the setting of the mixer shaft or mixing cartridge, mixed water is usually flushed out. However, it is sometimes not possible to ensure that sufficient water has been flushed out. For example, no or insufficient cold water may be flushed out if the mixer shaft is in a position that allows only or essentially a hot water flow. In addition, it is hardly sustainable if hot water is flushed out in situations in which only cold water needs to be flushed out in order to maintain the quality of the drinking water.

### SUMMARY OF THE INVENTION

The present invention is based on the object of creating a sanitary fitting of the type mentioned at the beginning, which offers intuitive manual operation for setting the water temperature and flow rate and also enables improved hygienic flushing.

This object is solved by a sanitary fitting with the features specified herein.

The sanitary fitting according to the invention comprises a fitting body, a water connection, a water outlet or water exit and a movable operating element having a lever. The lever can be rotated about a first axis of rotation to control a water temperature and can be tilted about a second axis of rotation to control a water flow (water volume flow). According to the invention, a sensor device for detecting various positions of the lever of the movable operating element relative to a fixed position of the fitting body is arranged in the fitting body.

The sanitary fitting according to the invention offers the user the manual operating convenience of a single-lever mixer. It thus offers simple, intuitive adjustability of the flow rate and water temperature. In addition, the sanitary fitting according to the invention offers the possibility of realizing an improved hygienic flush. For this purpose, a shut-off-device-free, in particular valve-free water line section is formed in the fitting body, which connects the water connection to the water outlet or water exit. The water line section corresponds to a section of a water pipe that ends with the water outlet or can be extended at the water exit by a further pipe section, for example in the form of a pipe section and/or a connecting bend. The shut-off-device-free water line section of the sanitary fitting according to the invention serves for drinking water utilization by supplying or forwarding drinking water that has been adjusted in terms of volume flow and water temperature for utilization purposes when drinking water is tapped. Furthermore, the water line section can be used advantageously for on-demand hygiene flushing of a drinking water pipe connected to it and arranged upstream in the direction of water flow. The water line section is preferably designed as a dead space-free or essentially dead space-free water line section.

The lever of the sanitary fitting according to the invention, which can be rotated about a first axis of rotation to control a water temperature and can be tilted about a second axis of rotation to control a water flow (water volume flow), can itself be designed as an actuating handle, i.e. the lever can be touched and actuated directly manually in such a case. Preferably, however, this lever is provided with a separately manufactured actuating handle which is connected, preferably detachably connected, to the lever. For this purpose, the lever can, for example, have a connecting section at its end facing away from the fitting body, which connection section is used for the positive and/or non-positive connection of a complementary actuating handle to the connecting section.

The actuating handle can be provided with a laterally protruding handle lever, as is the case with classic single-lever mixers. Such a handle lever is preferably provided in the sanitary fitting according to the invention. However, it is also within the scope of the invention to design the operating handle without a handle lever. For example, the operating handle can also be designed as a rotary handle. The operating handle designed as a rotary handle can have a classic or unusual handle shape. For example, the operating handle designed as a rotary handle can have a cylindrical, spherical, cubic, multi-edged, triangular, polygonal, cross-shaped, star-shaped or organic handle shape or outer contour.

The invention is based on the idea of providing an operating element for controlling an electronic mixing unit, by means of which the volume flow and temperature of drinking water to be dispensed can be adjusted, in the form or in the manner of a so-called single-lever mixer. With the sanitary fitting according to the invention, the advantages of the electronic mixing unit and the simple operation of a single-lever mixer can be combined.

In particular, the sanitary fitting according to the invention can be designed as a terminal sanitary fitting with a water outlet, for example as a washbasin or kitchen fitting. Alternatively, the sanitary fitting according to the invention can also be designed in the form of a so-called concealed single-lever mixer, in which case a section of the fitting body is intended and designed for a concealed arrangement in which the water connection and the water exit of the fully assembled sanitary fitting are concealed in a wall or a lined cavity, while the lever of the movable operating element is accessible on a surface, for example a shower wall, bathroom wall or shelf plate. A pipe section is connected to the water exit, for example a connecting bend, which is accessible at the surface and is intended, for example, for connecting a hand shower hose, an overhead shower, a bathtub water outlet or washbasin water outlet or any other water outlet.

An advantageous embodiment of the sanitary fitting according to the invention is characterized in that its sensor device comprises a Hall sensor. By means of a Hall sensor, various positions of the lever of the movable operating element relative to a fixed position of the fitting body can be reliably detected or determined. A Hall sensor enables reproducible detection and/or determination of different positions of the lever of a single-lever mixer relative to a fixed position of the fitting body. The Hall sensor can be used to measure magnetic strength and also the angle of incoming magnetic field lines. The Hall sensor is characterized by its compact dimensions so that it can be easily installed in the fitting body of the sanitary fitting, either on its own or in conjunction with an electronic circuit board. The circuit board is equipped with an electronic control unit.

A further advantageous embodiment of the invention provides for the operating element to comprise a pivot body which can rotate about the first axis of rotation and is mounted in a bearing body which can be fixed or is fixed in the fitting body. In this way, the intuitive operability of a single-lever mixer can be realized in a simple and reliable manner.

According to a further embodiment, the pivot body has aligned bores in which an axle body is mounted for tilting bearing the lever. By this embodiment design a defined tilting movement can be ensured. The bores and the axle body mounted therein preferably define the second axis of rotation about which the lever can be tilted or pivoted to control the flow of water.

A further embodiment of the sanitary fitting according to the invention provides that the pivot body has stops which limit the tilting movement of the lever. These stops are designed, for example, so that the lever can be tilted or pivoted from a starting position or closed position by up to approx. 45°, preferably by up to approx. 30°. However, other tilt angles (swivel angles) are also possible.

A further embodiment of the sanitary fitting according to the invention provides that the bearing body has stops limiting the rotation of the pivot body. These stops are designed in such a way that the lever can be rotated by approximately 90°, for example. One end of the range of rotation limited by the stops corresponds to a temperature setting in which, by means of an electronically controllable mixing unit upstream of the sanitary fitting, which has a valve for adjusting the volume flow of mixed water to be discharged via a mixed water line, only cold water is dispensed via the mixed water line when the valve for adjusting the volume flow is open. The other end of the rotation range limited by the stops, on the other hand, corresponds to a temperature setting in which only hot water is dispensed via the mixed water line by means of the electronically controllable mixing unit when the valve for setting the flow rate is open. Different mixed water temperatures can be set by turning the pivot body to different rotary positions between the two stops.

According to a further embodiment of the sanitary fitting according to the invention, the fitting body has a partition on the inside in the form of a base or a wall, wherein the bearing body is axially fixed to the partition with an intermediate arrangement of a sealing body. This embodiment allows an inner wet area of the fitting body to be sealed off in a watertight manner from a dry area for accommodating the sensor device in a structurally simple and reliable manner. The axial fixation of the sealing body to the partition can be realized, for example by means of a screw connection. The sealing body is preferably made of plastic and/or provided with a sealing ring made of elastomer, for example an O-ring.

Furthermore, an advantageous embodiment of the invention provides for an electrical and/or signal cable to be routed through the sealing body to the sensor device in a watertight manner. In particular, it is within the scope of the invention that a through-opening is provided in the above-mentioned partition, which is formed in the form of a base or a wall inside the hollow fitting body. Preferably, a cable bushing is inserted into the through-opening. The through-opening is preferably designed as a bore hole and can have an internal thread. The cable bushing has, for example, two sleeve parts screwed together and a sealing ring, wherein the sealing ring is pressed against the cable guided through the sleeve parts to form a radial seal when the sleeve parts are screwed together. One of the sleeve parts preferably has an external thread which is screwed into the internal thread of the through-opening.

According to a further embodiment, one or more blind holes for receiving a corresponding number of positioning pins are provided in the above-mentioned partition, which is formed in the form of a base or a wall inside the hollow fitting body, the positioning pin or positioning pins being firmly connected to the sealing body, for example being formed integrally with the latter.

A further advantageous embodiment of the sanitary fitting according to the invention is characterized in that a magnet is displaceably guided in the pivot body of the operating element, the magnet being displaceable by a tilting or pivoting movement of the lever.

The magnet is assigned to the sensor device by means of which the respective position of the lever of the operating element relative to the fixed position of the fitting body is detected, wherein the sensor device preferably comprises a Hall sensor.

The magnet is attracted, for example, by the axle body, which is made of magnetic metal, and thus held up underneath the lever or held laterally on the lever. As a result, the magnet can always be held on a predetermined path in the linear direction of the Z-axis or a longitudinal center axis of the lever. By tilting or pivoting the lever also the magnet is moved along the predetermined path, which can be detected, for example, by a Hall sensor and evaluated in an electronic system. A guide formed in the pivot body, which is defined for example by two guide slots, can hold the magnet in position against rotation on the Z-axis or a longitudinal center axis of the lever. The lever has a trough-shaped profile on the side facing the magnet, for example. The magnet can preferably be designed in the form of a cuboid bar magnet.

According to a further embodiment, the bearing body used for the rotary bearing of the pivot body is axially fixable or fixed in the fitting body by means of a hollow screw that can be screwed into an internal thread of the fitting body. This type of connection of the bearing body to the fitting body can be realized cost-effectively in terms of production technology and enables reliable watertight sealing of the said dry area, in which the sensor device is accommodated, from the inner wet area of the fitting body. In particular, this type of connection of the bearing body to the fitting body enables any necessary disassembly of the bearing body for maintenance or repair purposes.

In order to achieve haptics that corresponds to the haptics of a classic single-lever mixer or operating handle of a water valve (tap), a further embodiment of the sanitary fitting according to the invention provides that the pivot body and/or the lever of the operating element are/is provided with a friction element, for example in the form of a ball thrust piece or spring-loaded friction element or clampable ring, preferably an O-ring, or a pressed-in, protruding element made of elastomer. The more the friction element is clamped or pressed in, the greater the friction between the pivot body and the bearing body or between the lever and the pivot body. Accordingly, a greater actuating force must then be applied to turn the pivot body or to tilt or swivel the lever. In the sanitary fitting according to the invention, the friction can be predetermined or adjusted in such a way that the actuating force to be applied corresponds approximately to the actuating force that usually has to be applied to actuate a classic single-lever mixer, for example.

A further advantageous embodiment of the sanitary fitting according to the invention provides that the hollow screw is transparent. This allows light, in particular light of different light colors, which is emitted, for example, by a light-emitting diode associated with the sensor device, to be perceived on the outside of the sanitary fitting or transmitted to the outside of the sanitary fitting. The set temperature of drinking water to be dispensed via the sanitary fitting can be qualitatively indicated by means of different light colors, for example by emitting red light at a temperature setting at which hot drinking water would or will be dispensed. According to a further advantageous embodiment, the hollow screw is surrounded on the outside by a ring-shaped light guide.

A further advantageous embodiment of the sanitary fitting according to the invention is characterized in that the hollow screw has a circumferential, radially inwardly projecting web at its outer end. A correspondingly designed hollow screw allows both the bearing body and the pivot body of the operating element to be reliably secured in the fitting body in the axial direction in a simple manner.

According to a further advantageous embodiment of the invention, the bearing body is transparent at least in a body section facing the hollow screw, this body section of the bearing body preferably being provided on the inside with an annular light guide. The light guide is preferably designed in such a way that it defines a deflection surface, for example a conical deflection surface for light beams to be passed on. This allows the light emitted by the light source to be efficiently coupled out of the fitting body towards the outside of the sanitary fitting, starting from a light source, e.g. a light-emitting diode, arranged close to the sensor device, while ensuring a reliable mechanical connection between the bearing body, the pivot body and the fitting body.

The object set out above, on which the present invention is based, is solved in particular by a sanitary fitting system having the features specified in claim 15. The sanitary fitting system comprises a sanitary fitting according to the invention, preferably such a sanitary fitting according to at least one of the above-mentioned embodiments, and a mixing unit associated with the sanitary fitting and electronically controllable by means of the control element, wherein the mixing unit has a connection for cold water, a connection for hot water, a connection for a mixed water line connectable to the sanitary fitting, at least two independently from each other controllable valves for setting the temperature and volume flow of the mixed water to be dispensed via the connection for the mixed water line and drives controlling the valves.

The valves of the mixing unit are preferably designed as individually closable ceramic cartridges. This allows the mixing unit to be realized with very compact dimensions. The drives for controlling the valves are preferably independently controllable electric motors.

The mixing unit can be integrated into a drinking water management system, which comprises a networked electronics. The networked electronics can be scalably adapted to the specific requirements of each drinking water system. By means of a plurality of sensors, e.g. water temperature sensors and/or flow sensors, assigned controllers in the drinking water management system record the operating states of the drinking water system and the parameters that are crucial for maintaining the quality of the drinking water. These include, for example, the temperature level in the warm drinking water (hot water) and cold drinking water (cold water) as well as any interruptions in use. If defined target values are exceeded or not reached, the drinking water management system automatically triggers a hygiene flush as required.

### BRIEF DESCRIPTION OF THE DRAWINGS

The terms Fig., Figs., Figure, and Figures are used interchangeably in the specification to refer to the corresponding figures in the drawings.

The invention is explained in more detail below with the aid of a drawing showing examples of embodiments. The figures of the drawing are more or less schematically.

FIG. 1 shows a sanitary fitting according to the invention, which has an operating element with a tiltable and rotatable lever, in a perspective view in conjunction with an electronic mixing unit in a sectioned front view;

FIG. 2 shows a vertical sectional view of the sanitary fitting according to the invention shown in FIG. 1, with the lever of the operating element for dispensing drinking water in a tilted position;

FIG. 3 shows an upper section of the sanitary fitting from FIG. 2, again in a vertical sectional view, wherein the lever of the operating element is in a vertical starting position in which the dispensing of drinking water is blocked;

FIG. 4 shows the sanitary fitting in a horizontal sectional view along the sectional line IV-IV in FIG. 3;

FIG. 5 shows an upper section of the sanitary fitting from FIG. 1, but without lateral water outlet and without operating handle, in a perspective three-quarter vertical sectional view;

FIG. 6 shows a perspective view of the tiltable and rotatable lever with associated sensor device;

FIG. 7 shows an upper section of the sanitary fitting similar to FIG. 3 in vertical sectional view, but on a larger scale, without operating handle and without lateral water outlet;

FIGS. 8a and 8b show an upper section of the sanitary fitting similar to FIG. 7 in perspective three-quarter vertical sectional view, wherein the lever of the operating element in FIG. 8a is in a tilted position, whereas the lever in FIG. 8b is in the vertical starting position (closed position); and

FIGS. 9a and 9b show the lever of the operating element of the sanitary fitting with associated bearing body in two different perspective views, wherein the lever is in a tilted position in both FIG. 9a and FIG. 9b.

### DESCRIPTION OF THE INVENTION

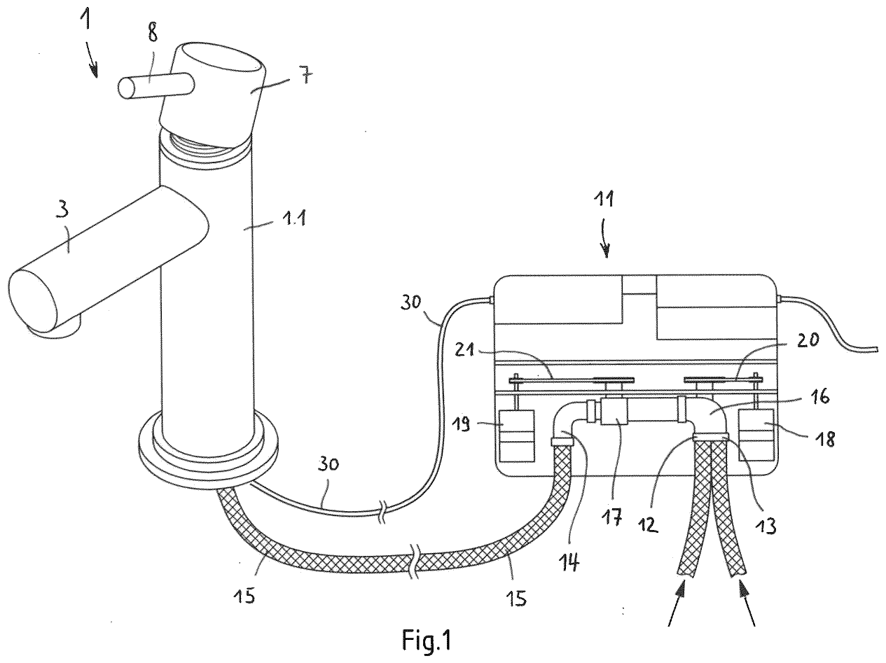

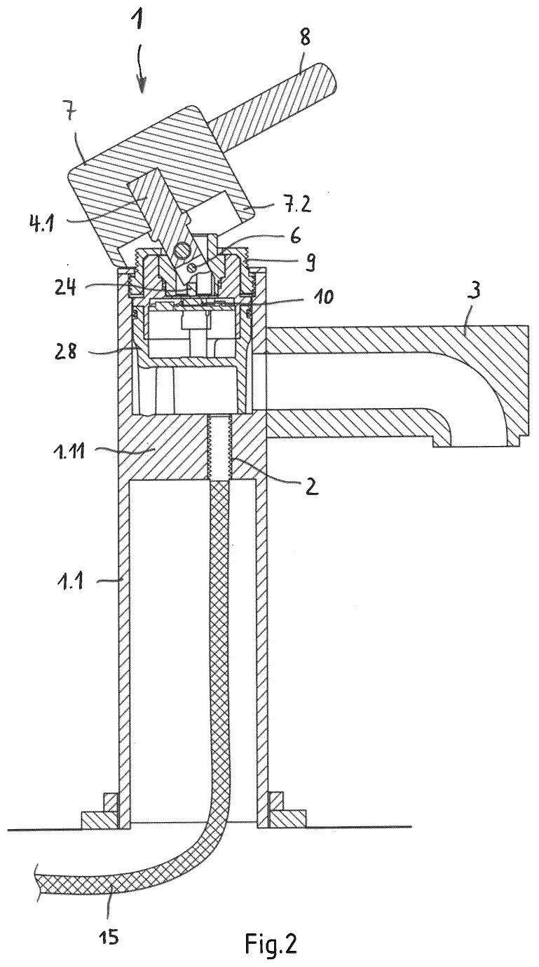

The sanitary fitting 1 according to the invention shown in the drawing, in particular in FIGS. 1 and 2, is similar in its appearance or shape and in its operability to a so-called single-lever mixer, as is known in particular as a terminal washbasin fitting or kitchen fitting.

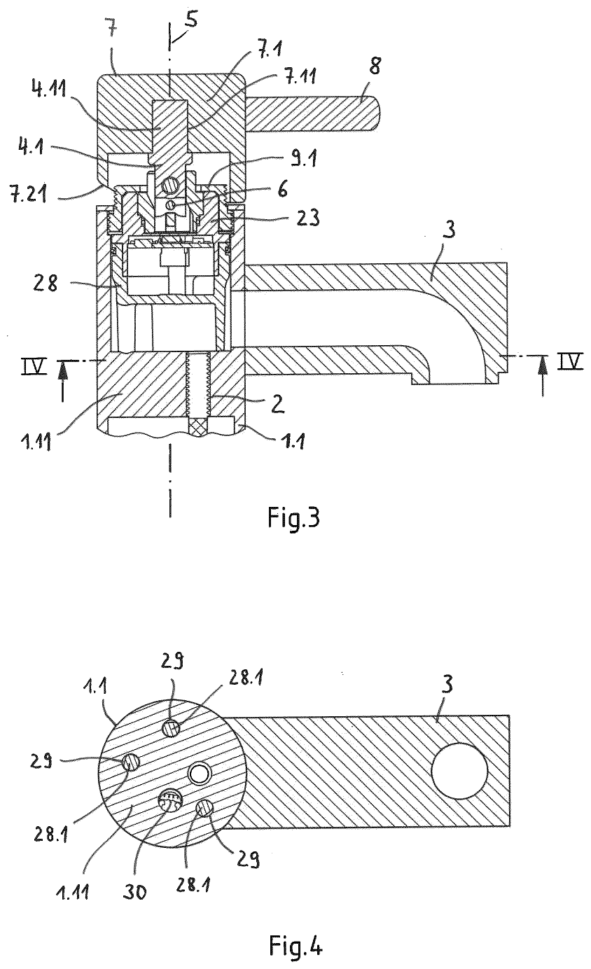

The sanitary fitting 1 has a fitting body 1.1 with a water connection 2, a water outlet 3 and a movable operating element 4 comprising a lever 4.1. The lever 4.1 can be rotated about a first axis of rotation 5, for example a vertical axis of rotation 5, to control the temperature of drinking water to be dispensed and can be tilted about a second axis of rotation 6 or an axis of rotation 6 extending transversely to the first axis of rotation 5 to control the water flow, i.e. the volume of water to be dispensed (cf. FIG. 3).

The lever 4.1 has a connecting section 4.11 at its end facing away from the fitting body 1.1. The connecting section 4.11 is used for the positive and non-positive connection of a complementary actuating handle 7. For this purpose, the connecting section 4.11 is designed, for example, in the form of a square pin. The actuating handle 7 comprises a connecting section 7.1 in which a hole 7.11 is formed for the positive fit of the connecting section 4.11 of the lever 4.1. The connecting section 7.1 of the actuating handle 7 is provided, for example, with a laterally protruding handle lever 8 and preferably has a lateral threaded hole (not shown) into which a grub screw (not shown) pressed against the connecting section 4.11 of the lever 4.1 is screwed. The connecting section 7.1 of the actuating handle 7 preferably has a collar 7.2 facing the fitting body 1.1, which engages around an upper or possibly lateral end of the fitting body 1.1 or a hollow screw 9, described in more detail below, which is screwed into an internal thread of the fitting body 1.1. The collar 7.2 has a chamfer 7.21 on one of its sides, which is essentially parallel to a pin or axle body 25 serving as a tilting bearing for the lever 4.1, which allows a certain tilting movement of the actuating handle 7 with the lever 4.1 attached to it, for example a tilting movement of maximum approx. 30° (cf. FIGS. 1 to 3).

If the operating handle 7, as shown in FIGS. 1 to 3, is provided with a laterally protruding handle lever 8, the chamfer 7.21 is preferably formed on the side of the operating handle 7 facing away from the handle lever 8. Such a handle lever 8 is preferably provided in the sanitary fitting according to the invention. However, as already noted above, it is also within the scope of the invention to design the actuating handle 7 without a handle lever 8. For example, the operating handle 7 can be designed as a rotary handle.

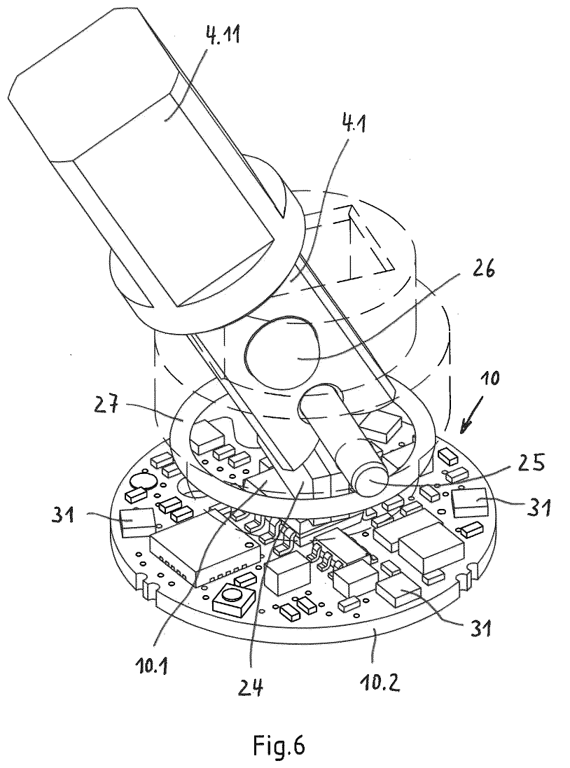

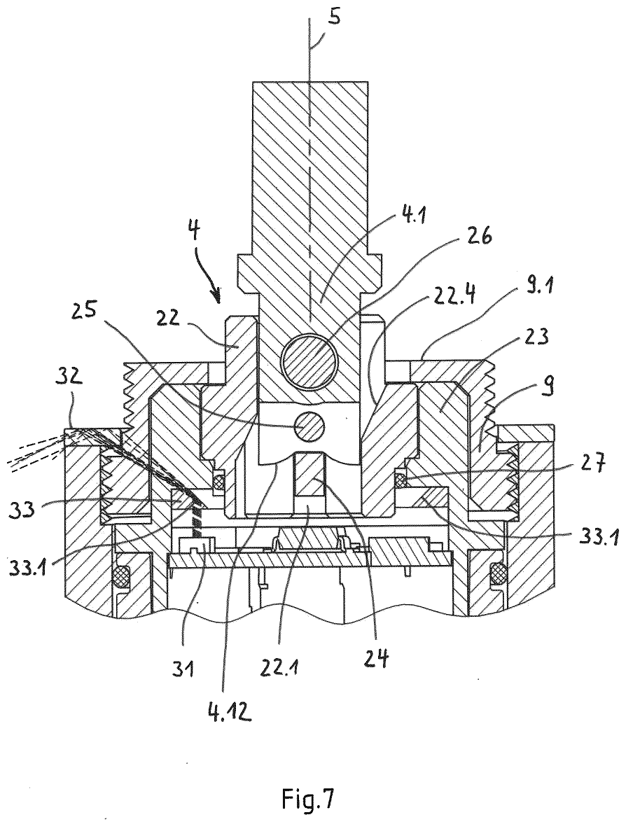

In contrast to a conventional single-lever mixer, the fitting body 1.1 of the sanitary fitting 1 shown in particular in FIG. 2 does not have a mechanical valve for controlling the water flow or for controlling the water temperature. Instead, a sensor device 10 is arranged in the fitting body 1.1 to detect the respective position of the lever 4.1 relative to a fixed position of the fitting body 1.1 (cf. particular FIGS. 6 and 7).

The sensor device 10 makes it possible to use the operating element 4 to control an electronic mixing unit 11 located at a distance from the sanitary fitting 1 (cf. FIG. 1). This electronic operability gives the user the operating experience of a classic, purely mechanically functioning single-lever mixer and thus the intuitive operation for setting the flow rate and temperature of the drinking water to be tapped.

The mixing unit 11 comprises a connection 12 for cold water, a connection 13 for hot water, a connection 14 for a mixed water line 15 that can be connected to the sanitary fitting 1, at least two independently from each other controllable valves 16, 17 for setting the temperature and/or flow rate of the mixed water to be dispensed via the connection for the mixed water line 15 and drives 18, 19 that control the valves 16, 17. The valves 16, 17 are preferably designed using ceramic cartridge technology. The respective cartridge-shaped valve 16, 17 has one or more ceramic disks with through-holes. The drives 18, 19 are preferably formed by electric motors, which are coupled to the movable valve bodies (not shown), preferably ceramic disks of the valves 16, 17, by gear transmissions 20, 21, for example gear wheel transmissions or gear wheel-toothed belt-transmissions (cf. FIG. 1). The mixing unit 11 can be arranged underneath a washstand or kitchen sink, for example.

Despite the mode of operation of the sanitary fitting 1 according to the invention, which corresponds to the mode of operation of a classic single-lever mixer, the sanitary fitting 1 according to the invention offers the user or the operator of a building with corresponding sanitary facilities the possibility of automated and/or remote-controlled flushing (hygiene flushing) of the water path defined by the sanitary fitting 1 in order to prevent critical drinking water stagnation and thus the risk of legionella formation. For this purpose, the mixing unit 11 is preferably included in a drinking water management system (not shown here in detail) of the type mentioned above.

The construction or design of the sanitary fitting 1 according to the invention results in a water path which is free of dead space or at least essentially free of dead space for tapping drinking water and for on-demand hygienic flushing of a drinking water pipe supplying the sanitary fitting 1.

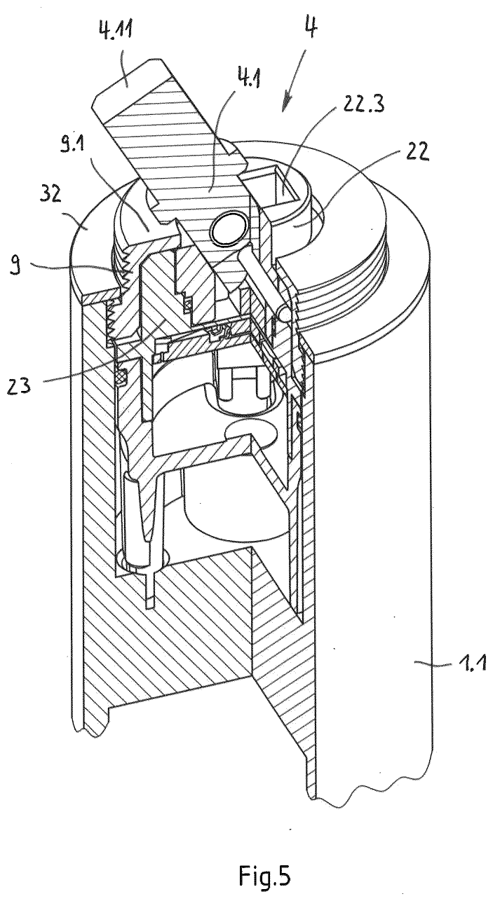

In order to precisely detect the respective position of the lever 4.1 of the operating element 4, the sensor device 10 arranged in the fitting body 1.1 preferably has a Hall sensor 10.1. The operating element 4 has a pivot body 22 that can rotate about the first or vertical axis of rotation 5 and is mounted in a bearing body 23 which is fixable or fixed in the fitting body 1.1 (cf. FIGS. 2, 3 and 5 to 8b). A magnet 24 is assigned to the Hall sensor 10.1. The magnet 24 is displaceably guided in the pivot body 22, whereby the magnet 24 can be displaced by a tilting movement of the lever 4.1 (cf. FIGS. 2, 3 and 5 to 8b). The lever 4.1 has a trough-shaped profile 4.12 on its side facing the magnet 24. The magnet 24 is preferably in the form of a cuboid bar magnet. Two guide slots 22.1 in the pivot body 22 hold the magnet 24 in position against rotation on a vertical axis or an axis running parallel to the first axis of rotation 5. The Hall sensor 10.1 is mounted on an electronic circuit board 10.2, which is protected in the fitting body 1.1 below or at a distance from the pivot body 22 (FIGS. 6 and 7).

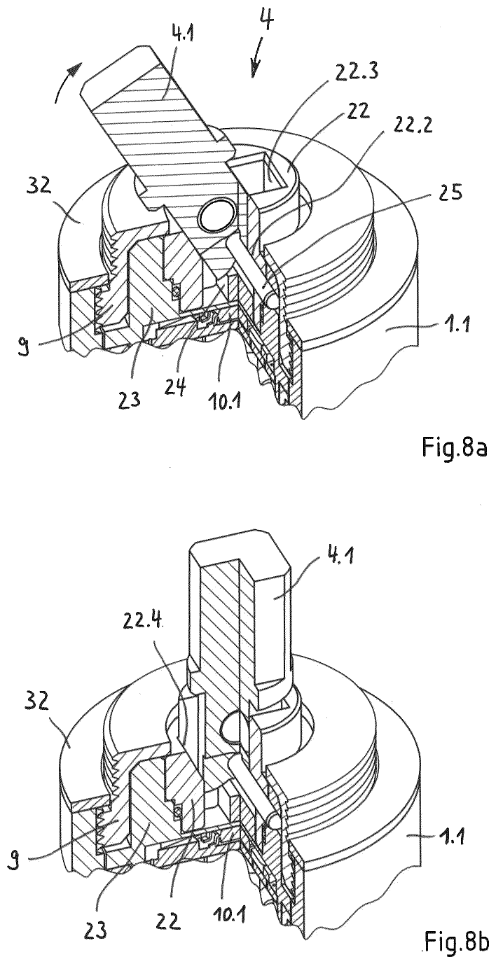

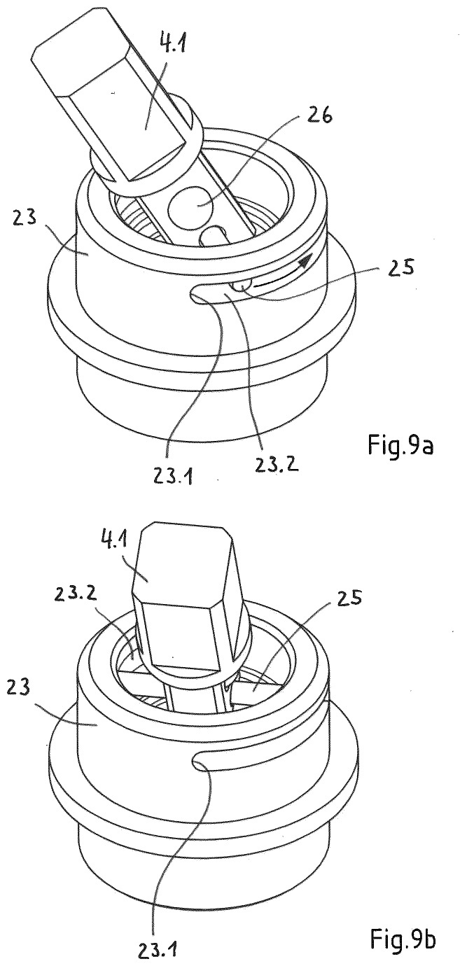

Furthermore, the pivot body 22 comprises bores 22.2 aligned with each other, in which the pin or axle body 25 is mounted for tilting the lever 4.1. Stops 22.3, 22.4 are formed in the pivot body 22, which limit the tilting movement of the lever 4.1 (FIGS. 8a and 8b). In addition, the bearing body 23 has stops 23.1, which limit the rotation of the pivot body 22 (FIGS. 9a and 9b). The stops 23.1 are defined by opposing partial circumferential slots 23.2 formed in the bearing body 23. The ends of the pin or axle body 25 penetrating the lever 4.1 engage with play in the partial circumferential slots 23.2.

Furthermore, the pivot body 22 and the lever 4.1 of the operating element 4 are provided with friction elements 26, 27. The friction elements 26, 27 improve the haptic impression that a user of the sanitary fitting 1 perceives when operating it manually. The friction elements 26, 27 or their friction is dimensioned, for example, so that the haptic when manually operating the sanitary fitting 1 according to the invention is similar to the haptic when operating a classic single-lever mixer or even surpasses the latter. A clampable or compressible O-ring (elastomer ring) is assigned to the pivot body 22 as a friction element 27, for example, while the lever 4.1 has a bore, for example, into which protruding cylinders or balls are inserted as friction elements 26. The cylinders or balls can be made of elastomer (cf. FIGS. 6 and 9a). Alternatively, spring-loaded thrust pieces, for example cylindrical or spherical thrust pieces, can be inserted into the bore as friction elements 26.

The fitting body 1.1 has a partition 1.11 on the inside in the form of a wall or a base, wherein the bearing body 23 is axially fixed to the partition 1.11 with an intermediate arrangement of a sealing body 28. A plurality of blind holes 29 are formed in the partition 1.11 for receiving a corresponding number of positioning pins 28.1. The positioning pins 28.1 are firmly connected to the sealing body 28, for example integrally connected to it. Also, the water connection 2 is formed in the partition 1.11 in the form of a through-hole with an internal thread (cf. FIGS. 2 and 4).

The bearing body 23 is axially fixable or fixed in the fitting body 1.1 by means of the hollow screw 9, which is screwed into the internal thread of the fitting body 1.1. The hollow screw 9 has a circumferential, radially inwardly projecting web 9.1 at its outer end. This web 9.1 additionally secures the pivot body 22 axially in the bearing body 23. An electrical and/or signal cable 30 is routed through the sealing body 28 to the sensor device 10 in a watertight manner. The other end of the electrical and/or signal cable 30 is connected to an electronic unit of the mixing unit 11. In particular, the cable 30 is used to supply power to the electronic circuit board 10.2.

One or more light sources 31, preferably light-emitting diodes, which can emit light of different colors, are attached to the circuit board 10.2, which carries the Hall sensor 10.1. Preferably, the at least one light-emitting means 31 is a multicolor light-emitting diode. Within the multicolor light-emitting diode there are at least three semiconductor crystals, each of which can generate light in one of the three primary colors red, blue and green. The combination of the light colors red and green results in yellow light; the combination of the light colors red and blue results in magenta; and the combination of the light colors green and blue results in cyan. For example, depending on the position of the lever 4.1 of the operating element 4, the light source 31 can illuminate red, yellow, green or blue to signal a setting of hot water, cold water or medium-temperature water. In order to qualitatively indicate the set water temperature on the sanitary fitting 1, the hollow screw 9 is transparent and is preferably surrounded on the outside by a ring-shaped light guide 32. In addition, the bearing body 23 is preferably also transparent at least in a body section facing the hollow screw 9, whereby this body section of the bearing body 23 is provided with an annular light guide 33 on the inside. The light guide 33 is designed such that it defines a deflection surface 33.1, for example a conical deflection surface 33.1 for light beams to be passed on (cf. FIG. 7).

The implementation of the invention is not limited to the embodiments shown in the drawing. Rather, numerous variants are conceivable which also make use of the invention stated in the claims in a design deviating from the examples shown. For example, the sanitary fitting 1 according to the invention can also be designed in the form of a so-called concealed single-lever mixer, wherein a section of the fitting body 1.1 is then intended for a concealed arrangement, e.g. a flush-mounted arrangement, and wherein the sanitary fitting 1 then has a concealed water exit instead of a water outlet, on which water exit a connection elbow or the like accessible on a surface, e.g. a shower wall or room wall, can be installed.

As can be seen from the above description, the present invention offers or enables the following advantages:
Intuitive operability of the operating element analogous to a single-lever mixer
Dead space-free water path for tapping drinking water and for hygienic flushing
Remote-controlled flushing and/or presetting of defined water temperatures possible
Automated, on-demand flushing of hot and/or cold water pipes possible
Drinking water temperature range can be set centrally by the operator to ensure protection against scalding and energy savings
Temperature-controlled hygienic flush for on-demand hygienic flushing
Hygienic cartridge technology with ceramic discs
Reduction of pressure surges compared to the use of solenoid valves
Improved robustness with regard to particles contained in drinking water
Cartridge valves with ceramic discs are free of dead space

1. A sanitary fitting comprising
a fitting body,
a water connection,
a water outlet or water exit and
a movable operating element having a lever,
wherein the lever is rotatable about a first axis of rotation to control a water temperature and is tiltable about a second axis of rotation to control a water flow, and
wherein a sensor device for detecting various positions of the lever relative to a fixed position of the fitting body is arranged in the fitting body.

2. The sanitary fitting according to claim 1, wherein the sensor device comprises a Hall sensor.

3. The sanitary fitting according to claim 1, wherein the operating element comprises a pivot body which is rotatable about the first axis of rotation and is mounted in a bearing body which is fixable in the fitting body.

4. The sanitary fitting according to claim 3, wherein the pivot body and/or the lever of the operating element are/is provided with a friction element, preferably in the form of a spring-loaded friction element or clampable ring or pressed-in, projecting element made of elastomer.

5. The sanitary fitting according to claim 3, wherein the pivot body comprises mutually aligned bores in which an axle body for the tilting bearing of the lever is mounted.

6. The sanitary fitting according to claim 3, wherein the pivot body has stops which limit a tilting movement of the lever.

7. The sanitary fitting according to claim 3, wherein the bearing body has stops which limit a rotation of the pivot body.

8. The sanitary fitting according to claim 3, wherein the fitting body has a partition on the inside in the form of a base or a wall, the bearing body being axially fixed to the partition with an intermediate arrangement of a sealing body.

9. The sanitary fitting according to claim 8, wherein an electrical and/or signal cable is guided through the sealing body to the sensor device in a watertight manner.

10. The sanitary fitting according to claim 3, wherein a magnet is displaceably guided in the pivot body, the magnet being displaceable by a tilting or pivoting movement of the lever.

11. The sanitary fitting according to claim 3, wherein the bearing body is axially fixable in the fitting body by means of a hollow screw, which can be screwed into an internal thread of the fitting body.

12. The sanitary fitting according to claim 11, wherein the hollow screw is transparent.

13. The sanitary fitting according to claim 11, wherein the hollow screw is surrounded on the outside by an annular light guide.

14. The sanitary fitting according to claim 11, wherein the hollow screw has a circumferential, radially inwardly projecting web at its outer end.

15. The sanitary fitting according to claim 11, wherein the bearing body is transparent at least in a body section facing the hollow screw, this body section of the bearing body preferably being provided on the inside with an annular light guide.

16. The sanitary fitting system having a sanitary fitting according to claim 1 and a mixing unit associated with the sanitary fitting and electronically controllable by means of the operating element, wherein the mixing unit has a connection for cold water, a connection for hot water, a connection for a mixed water line connectable to the sanitary fitting, at least two independently from each other controllable valves for setting the temperature and volume flow of the mixed water to be dispensed via the connection for the mixed water line and drives controlling the valves.
